(19) United States
(12) Patent Application Publication
(10) Pub. No.: US 2017/0262811 A1
(43) Pub. Date: Sep. 14, 2017

(54) RESUME TOOL

(71) Applicant: Jeffrey Mark Ovadya, Sunnyvale, CA (US)

(72) Inventor: Jeffrey Mark Ovadya, Sunnyvale, CA (US)

(21) Appl. No.: 15/452,561

(22) Filed: Mar. 7, 2017

Related U.S. Application Data
(60) Provisional application No. 62/305,458, filed on Mar. 8, 2016.

(51) Int. Cl. G06Q 10/10; G06F 17/21; G06F 17/24

(52) U.S. Cl. CPC G06Q 10/1053; G06F 17/243; G06F 17/241; G06F 17/212; G06F 3/0484

(57) ABSTRACT

A résumé tool used to build a résumé includes a résumé customization tool that adds and removes items to a selected résumé. The résumé customization tool includes for each résumé a list of included items, a list of items or grouping of items omitted from the résumé, a hide selection that moves an item or grouping of items from the list of included items to the list of items omitted from the résumé, and a selection that moves an item from the list of items omitted from the résumé to the list of included items.

### CROSS-REFERENCES TO RELATED APPLICATIONS

This application claims priority from U.S. Provisional Application Ser. No. 62/305,458 filed Mar. 8, 2016, which is hereby incorporated herein by reference in its entirety.

### BACKGROUND

Résumé builders available on various websites over the Internet allow a prospective employee the opportunity to design and produce résumés that can be distributed to prospective employers and recruiters. Résumé builders such as available on résumégenius.com often include templates and a selection of prior written bullet points that allow convenient and expedient generation of a résumé.

### BRIEF DESCRIPTION OF DRAWINGS

FIG. 1 is a simplified block diagram that illustrates interactions within a résumé building system in accordance with an implementation.

FIG. 2 is a flowchart that illustrates a résumé creation from a template process in accordance with an implementation.

FIG. 3 is a flowchart that illustrates a process by which a user adds clients to an employer position entry.

FIG. 4 illustrates a process of an integrated accomplishment-creation tool that is used by résumé writers to develop stories that qualify their competencies in accordance with an implementation.

FIG. 5 illustrates how a user quickly and easily copies select accomplishments from employment and education résumé branches to a highlight résumé branch in accordance with an implementation.

FIG. 6 illustrates how a layout is applied to any given segment of a template and/or résumé in accordance with an implementation.

FIG. 7 illustrates processes involved in résumé publication in accordance with an implementation.

FIG. 8 displays a résumé customization tool's opening page in accordance with an implementation.

FIG. 9 illustrates a résumé-template type selector, where a user informs an enterprise system which type of résumés are to be produced from a current template in accordance with an implementation.

FIG. 10 displays a newly-created template for typical chronological résumé in accordance with an implementation.

FIG. 11 displays a user's ability to modify identity information in accordance with an implementation.

FIG. 12 shows a résumé spawned from its template and exposing various content layout controls in accordance with an implementation.

FIG. 13 illustrates how a segment manages its own layout independently, overriding inherited layouts in accordance with an implementation.

FIG. 14 shows controls to include previously-created items, remove irrelevant items and irrelevant item-groupings or, create new items in accordance with an implementation.

FIG. 15 shows control to add another group of item controls in accordance with an implementation.

FIG. 16 demonstrates layout customization granularity, revealing how clients are rendered in position in accordance with an implementation and, hoe individual positions may differ in their rendering.

FIG. 17 displays activation of accomplishments-creation tool in accordance with an implementation.

FIG. 18 displays accomplishment-creation work-area in accordance with an implementation.

FIG. 19 displays an example of a completed accomplishment in accordance with an implementation.

FIG. 20 reveals how a completed accomplishment is rendered in template- and résumé-creation form in accordance with an implementation.

FIG. 21 displays a layout containing accomplishment in accordance with an implementation.

FIG. 22 shows an email form used to send a résumé in accordance with an implementation.

FIG. 23 displays a résumé publishing tool in accordance with an implementation.

FIG. 24 illustrates existence of, and ability to add, several residences to a résumé in accordance with an implementation.

FIG. 25 shows a display of statistical data about all employers and agencies that viewed each published résumé in accordance with an implementation.

FIG. 26 shows a display of messages from agencies and from employers offering job opportunities in accordance with an implementation.

FIG. 27 is a simplified flow chart for a résumé search tool in accordance with an implementation.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

In accordance with various implementations, the platform disclosed herein provides tools that assist a user in quickly producing an effective résumé that can be highly-personalized and that offers great advantages to job seekers, employers and recruitment agencies. Integrated tracking and guidance tools allow a user to track sent résumés sent both to recipients and beyond, annotate sent résumés, schedule and prepare for interviews, annotate and rate interviews and interviewers, create and track private interview-preparation notes and, annotate and rate employers and employment agencies.

The platform enables the user to create and leverage personal networks to assist with morale while unemployed, identifying new employment opportunities, developing employment and career-development strategies, employer research, enhancing résumés, submitting résumés and tracking résumés.

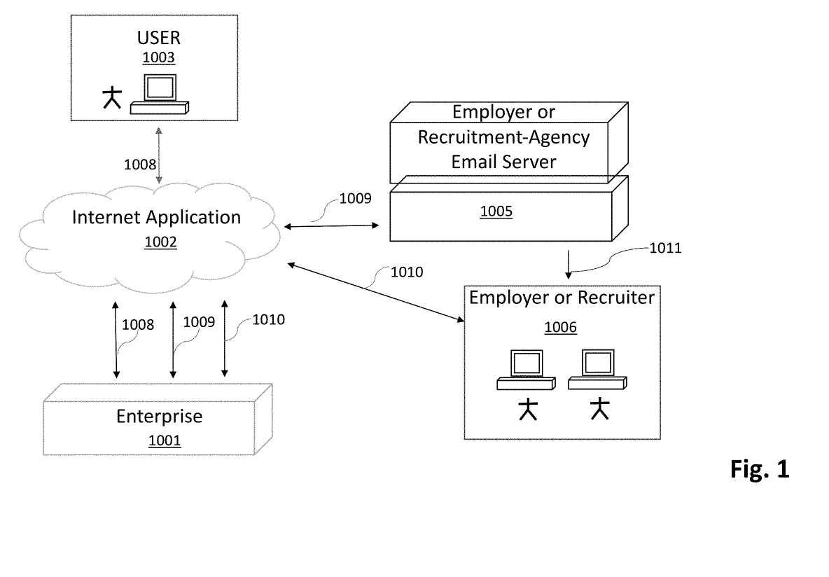

FIG. 1 shows an enterprise server system 1001 that communicates through an internet application 1002 to a user 1003 as illustrated by arrows 1008. For example, enterprise system 1001 is composed of one or more servers. Enterprise system 1001 also communicates through internet application 1002 to a recruitment-agency or employer 1006 as illustrated by arrows 1010. Enterprise system 1001 also communicates through internet application 1002 with an email server 1005 that services employer or recruitment-agency as illustrated by arrows 1009. Email server 1005 communicates with employer or recruitment-agency 1006 as illustrated by an arrow 1011.

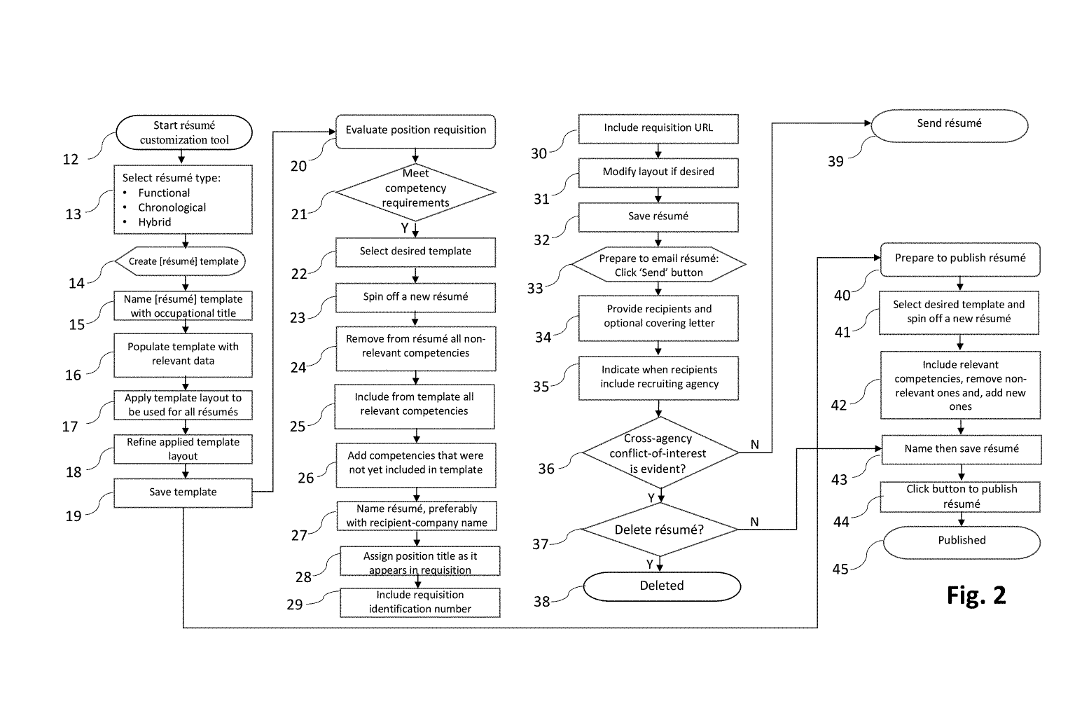

FIG. 2 is a flowchart that illustrates how user 1003 engages internet application 1002 to produce position-relevant résumés. The process starts with a user 1003 who wants to commence using a résumé customization tool as indicated in a block 12. User 1003 indicates to internet application 1002 the type of résumé that is to be produced as indicated in a block 13, then internet application 1002 responds by displaying a résumé template form, as indicated in a block 14. User 1003 names the template as indicated in a block 15, and proceeds to provide relevant data as indicated in a block 16. Thereafter, user 1003 selects a résumé layout as indicated in a block 17 and then refines segments of selected layout as indicated in a block 18. User 1003 instructs internet application 1002 to save completed template as indicated in a block 19.

Next in FIG. 2, user 1003 reviews a requisition to determine personal competency in meeting its requirements as indicated in a block 20, and discovers that position described is indeed viable as indicated in a block 21. User 1003 proceeds to create a new résumé as indicated in a block 23 from a desired template as indicated in a block 22 and removes from the résumé to the sidebar all irrelevant professional skills and irrelevant competencies as indicated in a block 24, then includes previously-removed relevant skills and competencies from sidebar as indicated in a block 25. User 1003 then adds new relevant skills and competencies as indicated in a block 26. User 1003 names the new résumé as indicated in a block 27, appends a position title as indicated in a block 28, and includes a requisition identification number as indicated in a block 29 and an internet address to where requisition resides on a website as indicated in a block 30. User 1003 optionally enhances the layout as indicated in a block 31 before saving résumé as indicated in a block 32.

Also in FIG. 2, user 1003 prepares to send the résumé as indicated in a block 33. User 1003 addresses recipients and optionally adds a covering letter as indicated in a block 34 and indicates if among recipients is a recruitment-agency as indicated in a block 35. Internet application 1002 informs user 1003 if sending the current résumé will evoke a cross-recruitment-agency conflict-of-interest as indicated in a block 36, and if so then user may decide to delete the résumé as indicated in a block 37 or else rename and save it as indicated in a block 43 and then publish it as indicated in a block 44. Otherwise, user 1003 may proceed to send the résumé as indicated in a block 39.

Further FIG. 2 illustrates an example of user 1003 publishing a résumé as indicated in a block 40. User 1003 creates new résumé from a desired template as indicated in a block 41 and updates its content as indicated in a block 42. User 1003 names and saves the résumé as indicated in block 43 then proceeds to publish it as indicated in block 44.

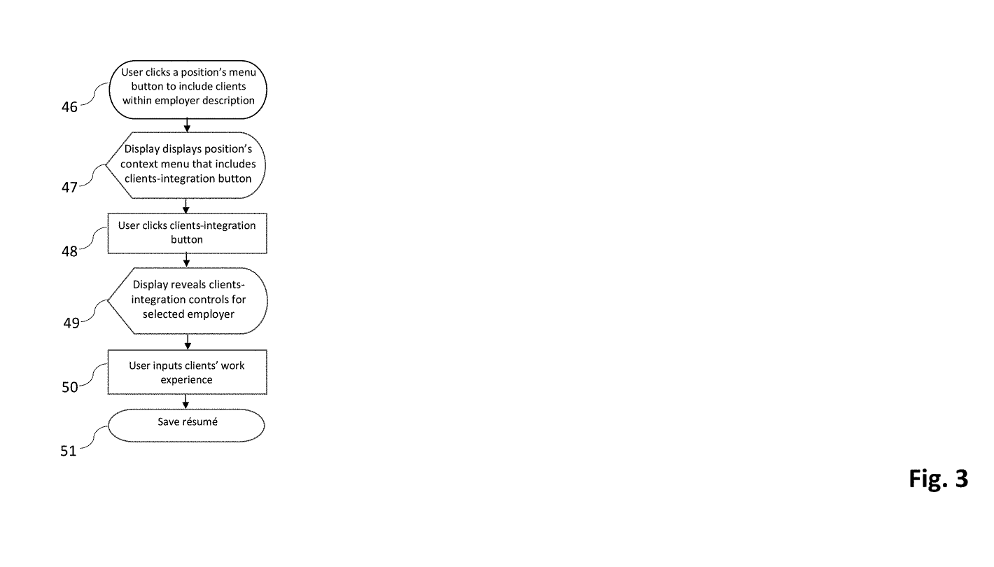

FIG. 3 illustrates user 1003 clicking relevant position menu button to display experience working with an employer's client as indicated in a block 46, and internet application 1002 responds by presenting a context menu with a client integration button as indicated in a block 47. User 1003 clicks the clients-integration button as indicated in a block 48, and internet application 1002 responds by displaying clients-integration controls for relevant employer as indicated in a block 49. User 1003 proceeds to input client-experience as indicated in a block 50, and thereafter saves résumé as indicated in a block 51.

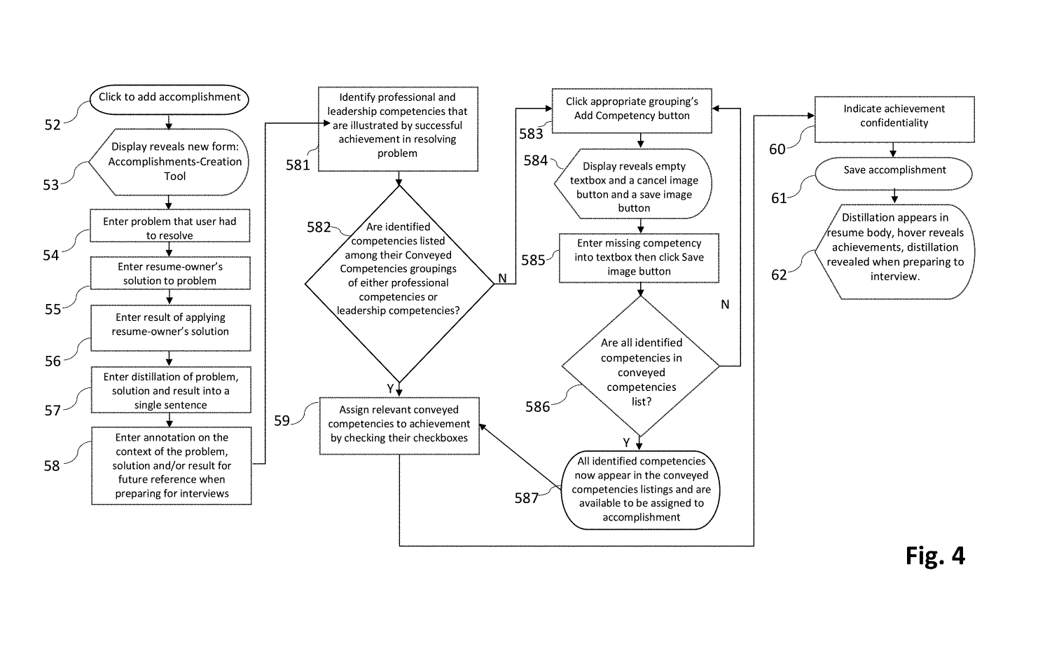

FIG. 4 illustrates user 1003 adding an accomplishment that relates an achievement that was contributed to an employer, client or educational institution as indicated in a block 52. Internet application 1002 responds by displaying an integrated accomplishment-creation tool, that includes a new form that presents user 1003 with new accomplishment-management controls as indicated in a block 53. User 1003 describes a problem that required a professional solution as indicated in a block 54. Then user 1003 describes a personal solution as indicated in a block 55, then the user describes successful results of personal solution as indicated in a block 56. User 1003 then combines problem, solution and result into a single distilled sentence as indicated in a block 57, and adds context information describing accomplishment as indicated in a block 58. User 1003 then identifies any of two types of competencies, professional and leadership, that are evident from accomplishment as indicated in a block 581, then user checks to see if identified competencies are listed in conveyed competencies listing as indicated in a block 582. If any identified competencies are not listed among their groupings of conveyed competencies then user 1003 clicks an add competency button for an appropriate grouping as indicated in a block 583, and internet application 1002 displays a textbox control, a cancel image button control and a save image button control as indicated in a block 584. User 1003 enters one of the missing competencies and then clicks the save image button as indicated in a block 585. If additional identified competencies are still missing from the conveyed competencies listing then user returns to the process indicated in block 583 until all identified competencies are in their appropriate groupings as indicated in a block 587. Thereafter, user 1003 assigns the identified competencies to the achievement as indicated in a block 59. This means that the accomplishment is linked to the competency. User 1003 indicates if the accomplishment contains confidential information as indicated in a block 60, and then saves the accomplishment as indicated in a block 61. Internet application 1002 displays a distilled portion within template-form or résumé-form body as indicated in a block 62.

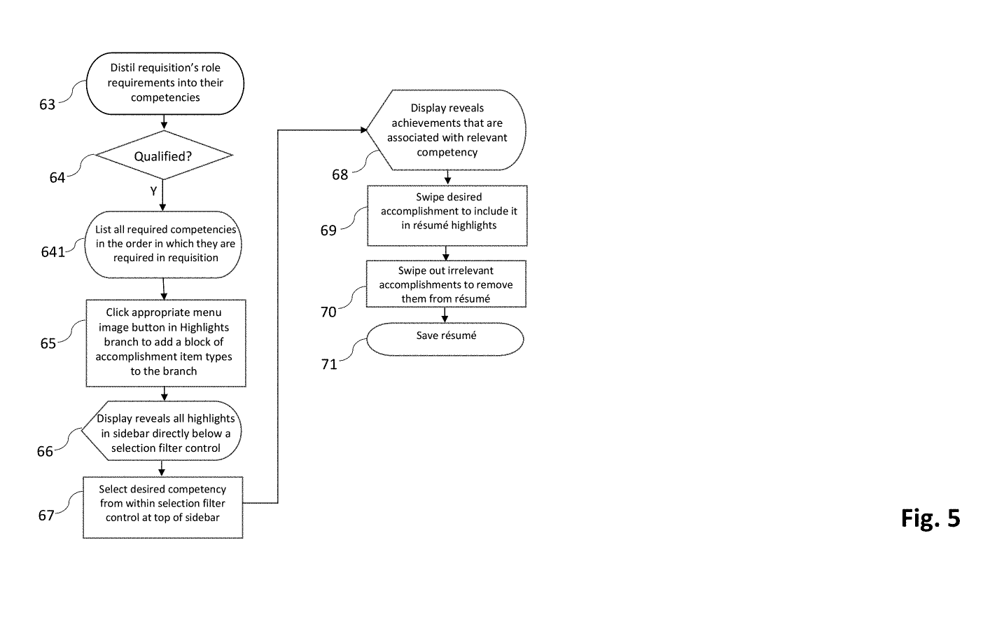

FIG. 5 illustrates user 1003 distilling requisition requirements into competencies as indicated in a block 63 to determine if qualified for role as indicated in a block 64. Upon qualification, lists all competencies required by requisition in the order in which they appear in requisition, as indicated in a block 641. User 1003 then navigates to résumé's Highlights branch and adds a block of accomplishment item types to the highlights branch as indicated in a block 65, and internet application 1002 responds by listing all available accomplishments from Employment and Education branches—whether included in résumé or omitted—in the sidebar, as indicated in a block 66. For each required competency, user 1003 selects that competency in the selection control atop the sidebar, as indicated in a block 67. Internet application 1002 restricts accomplishments displayed in sidebar to those that are associated with desired competency, as indicated in a block 68. User 1003 clicks relevant image button to swipe desired accomplishment into highlights branch, as indicated in a block 69. If an irrelevant accomplishment exists in branch then click on appropriate image button to swipe it out of the Highlights branch, as indicated in a block 70. User 1003 saves résumé when done, as indicated in a block 71.

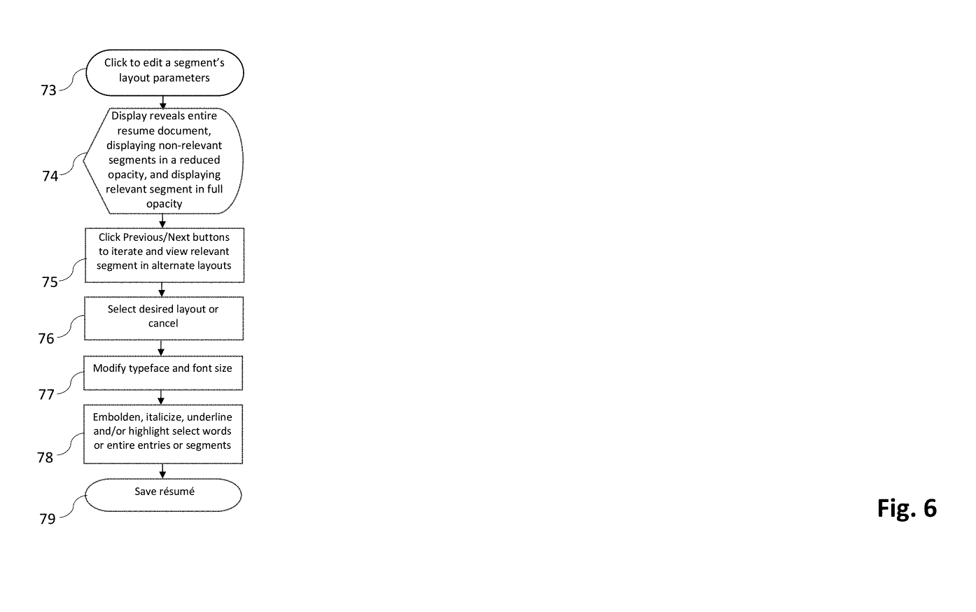

FIG. 6 illustrates a layout being applied to any given segment of a template and/or a résumé. In a block 73, a user clicks to edit a segment's layout parameters. In a block 74 a resulting display reveals an entire résumé in final printable format; however, the entire résumé is reduced in opacity except where the résumé segment is edited which is displayed in full opacity. In a block 75, the user clicks a “Previous” button or a “Next” button to iterate numerous available layouts. In a block 76, the user selects desired layout, and in a block 77 the user may modify typeface and font size. In a block 78, the user may embolden, italicize, underline and/or highlight select words or entire entries or segments. In a block 79, the user saves the résumé.

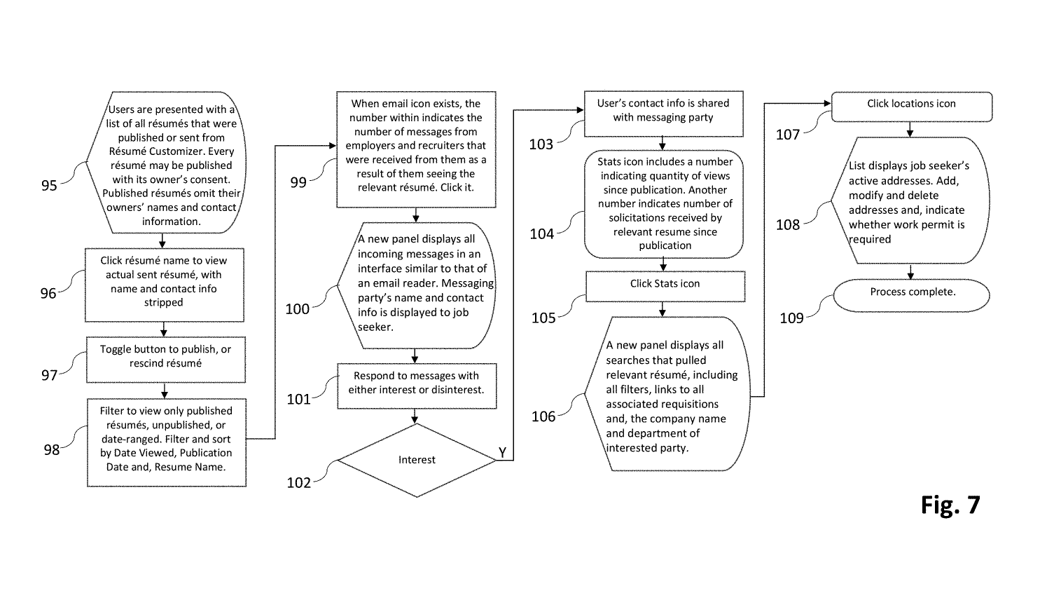

FIG. 7 illustrates the processes involved in résumé publication. In a block 95, a user is presented with a list of all résumés that were published or sent from the résumé customizer. Every résumé may be published with consent of the owner of the résumé. Published résumés omit the name and contact information of the owner of the résumé. In a block 96, a user clicks a résumé to view the actual sent résumé from which the name and contact information were removed. In a block 97, a toggle button is used to publish or rescind a résumé. In a block 98, a filter can be used to view only published résumés, unpublished résumés or résumés published in a certain data range. The résumés can be filtered and sorted by date viewed, publication date and résumé name.

In a block 99, when an email icon exists in line with a résumé name, the icon can include a number indicating the quantity of unanswered active messages from employers and recruiters that were received from employers and recruitment-agents who responded to the relevant résumé.

For example, the messages are accessed by clicking the email icon. In a block 100, a new panel displays all incoming messages in an interface similar to that of an email reader. The name and contact information of the messaging party is displayed to the user. In a block 101, the user can respond to the messages either with interest or disinterest. In a block 102, for example, the user responds with interest. In a block 103, having responded with interest, the user's contact information is shared with the messaging party. In a block 104, a stats icon that is in line with the résumé name includes a number that indicates a quantity of views since publication. Another number displayed in the stats icon indicates a number of solicitations received by a relevant résumé since publication. In a block 105, the user clicks the stats icon and as a result, in a block 106, a new panel displays all searches that pulled relevant résumés, including all filters used by searcher, links to associated requisitions and, the searching department's name and location, its company name and, the name of the person to whom relevant search account is registered.

In a block 107, a user can click a location icon, and as a result, in a block 108, there is displayed a list of the user (i.e., the job seeker's) active addresses. The user can add, modify and delete addresses and indicate whether a work permit needs to be acquired to work at listed location. In a block 109 the process is complete.

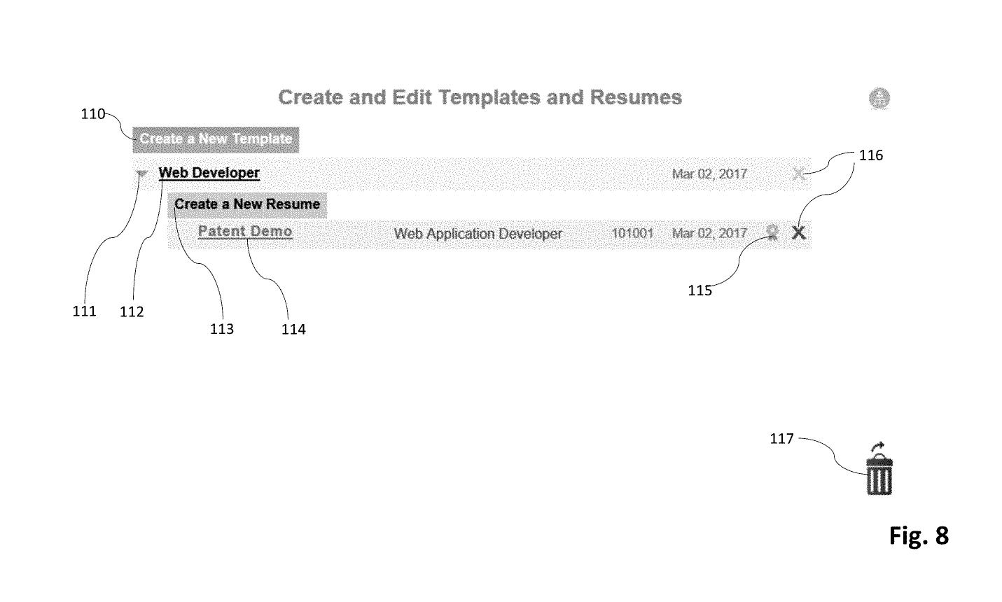

FIG. 8 displays a résumé customization tool's opening page. A user can select a button 110 to create a new template. A user 1003 can click a toggle button 111 to expand and view its contents indented below it. Also, a user 1003 can click a link button titled Web Developer 112 to view and edit previously-saved template of the same name. User 1003 can also click a link button titled Create a New Résumé 113 to have internet application 1002 spawn a new résumé of its parent template type. The user may also click a link button 114 titled Patent Demo to have internet application 1002 display previously-saved résumé of that name so that user may continue working with it. The user may also click an image button 115 to overwrite template's included items with its own, so that from thence any time a new résumé is spawned from same template it will by default include exclusively the same items. The user may also delete a résumé or template by clicking a button 116. The user can click an image button 117 to view deleted résumés and deleted templates, from where they may be purged or restored.

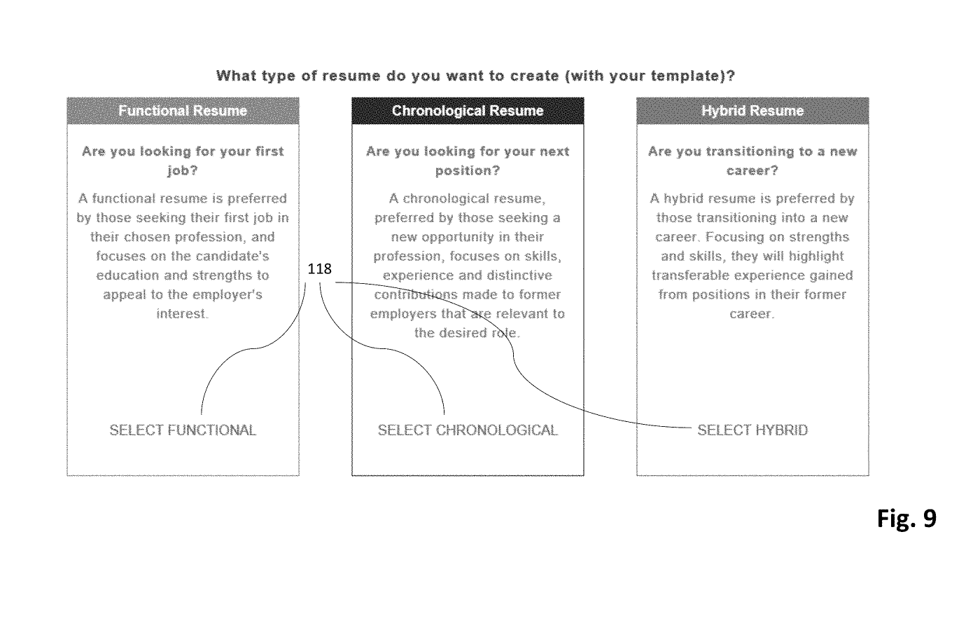

FIG. 9 illustrates a template type selector window. A user can select one of buttons 118 to select a functional résumé, a chronological résumé or a hybrid résumé. The résumé template type selected determines the branches that are to be included in the template's résumés and the order in which they will provide greatest effect in eliciting employer interest.

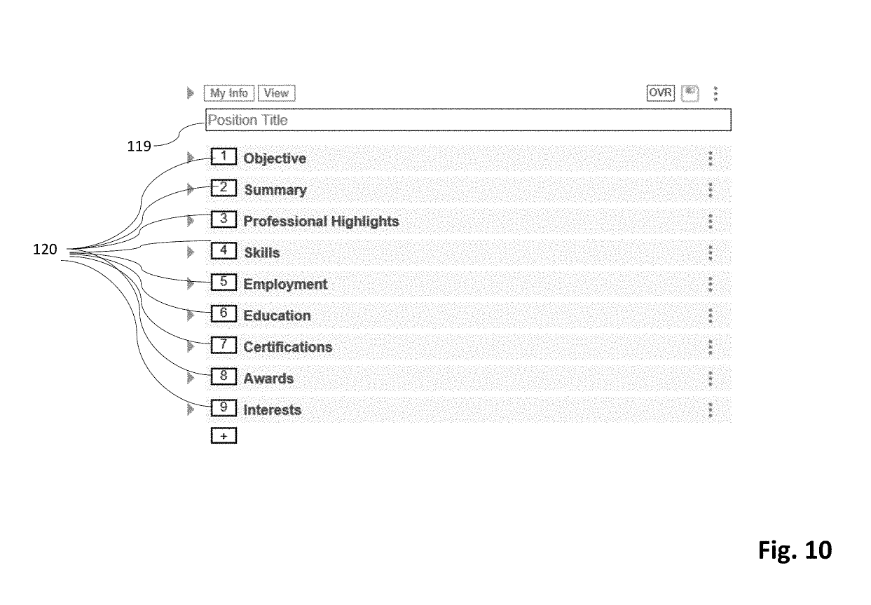

FIG. 10 displays newly-created template for typical chronological résumé. A user can fill in a position title in a box 119. Textboxes 120 indicate the order of template's branches; modifying any one of the ordinals reorders template's branches as modified.

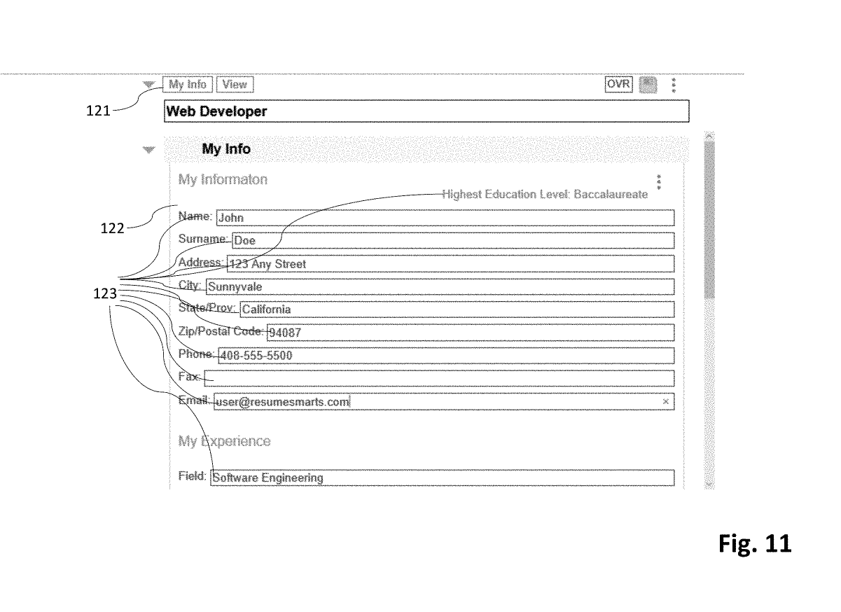

FIG. 11 displays a button 121 that, when toggled, displays a panel 122 that reveals user name and info in textboxes 123 as inherited from internet application 1002 and, wherein user 1003 may modify name and contact information so as to obscure identity from résumé recipients.

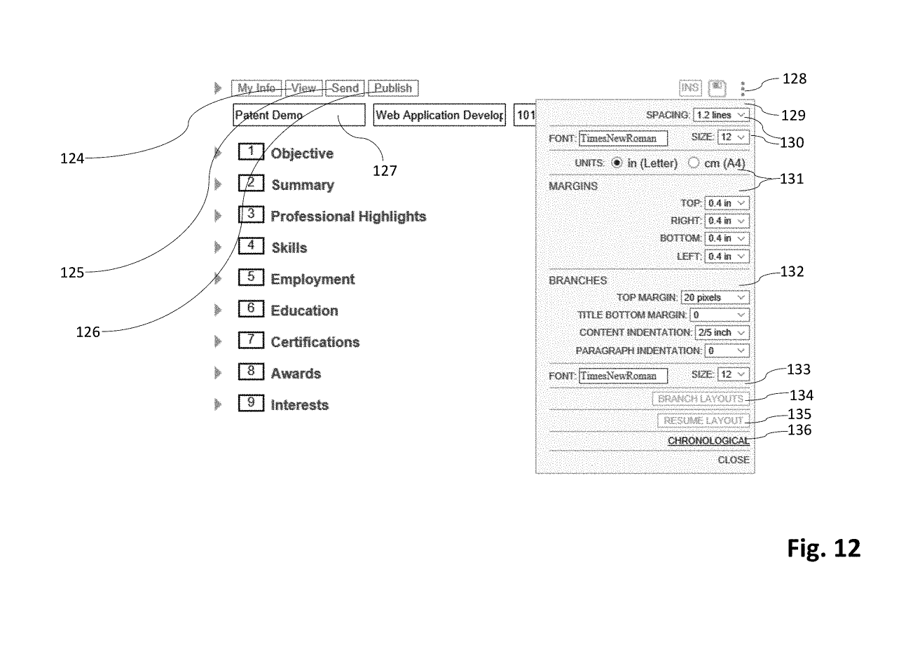

FIG. 12 shows a window for a résumé labeled “patent demo” whose template type is chronological. Clicking a button 124 titled “View” causes internet application 1002 to display the résumé formatted as a document. Clicking a button 125 titled “Send” displays a send résumé form where user 1003 enters résumé recipient email addresses and other relevant data. Clicking a button 126 titled “Publish” publishes the résumé. Textbox 127 indicates the résumé name as entered by user when initially created, and is intended to represent the employer's company name. An image button 128 displays a context menu 129, offering controls to modify whatever is supported by the object whose menu was clicked. Controls 130 enable user 1003 to modify résumé-wide line-spacing, typeface and font-size. Controls 131 enable user 1003 to modify résumé's margins, and to toggle their units between metric and imperial. Control-group 132 offers controls that enable user to modify various branch properties, as indicated. Controls 133 enable user to modify a branch titles' typeface and font size. A button 134 enables user to modify a branch titles' layout while overriding the résumé's master layout. A button 135 enables user 1003 to apply a master layout to the entire résumé that will be applied wherever it is not overridden. A button 136 titled according to its template type, when clicked, will present user 1003 with controls defined in FIG. 9, enabling user 1003 to transform the current template type into a new type that is selected.

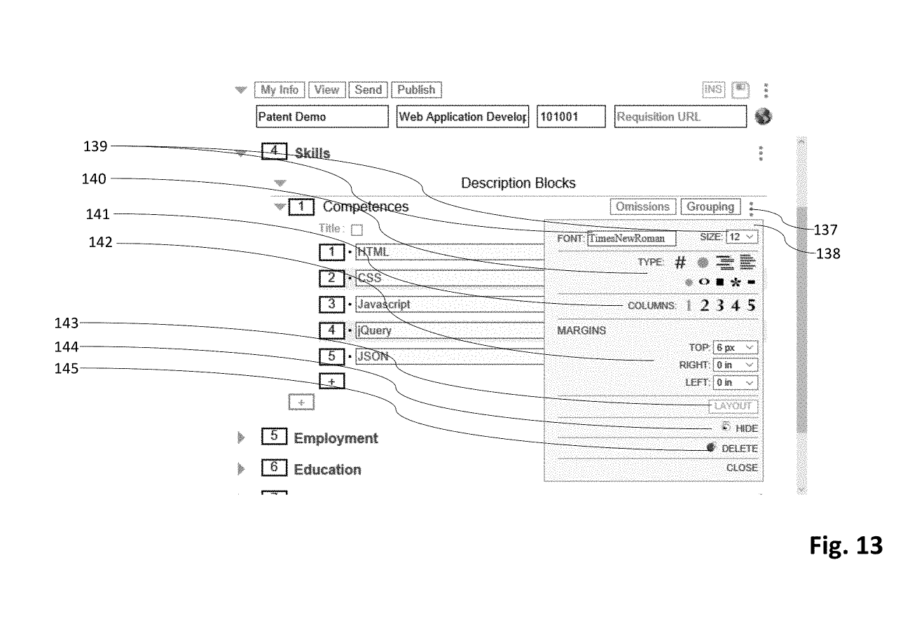

FIG. 13 shows a button 137 that, when clicked, displays its context menu 138 that controls the items in its grouping. Buttons 139 modify typeface and font-size. Buttons 140 determine the type of items in the group, ranging from unordered (bulleted, various bullet types) list items, to ordered (numbered, various numbering systems) list items, dictionary list (uniquely-titled) items, paragraphs and, when available, accomplishments. Selected button from button-group 141 determines the number of columns, one through five, that will be used to display the grouping's items. Selection buttons 142 modify the grouping's top and side margins. A button 143 titled “Layout” presents user 1003 with controls to modify a selected segment's layout as illustrated in FIG. 6. A button 144 enables user 1003 to hide a grouping of items when applying for a position for which its items are irrelevant. A button 145 enables user 1003 to delete grouping and all of its contents entirely from template.

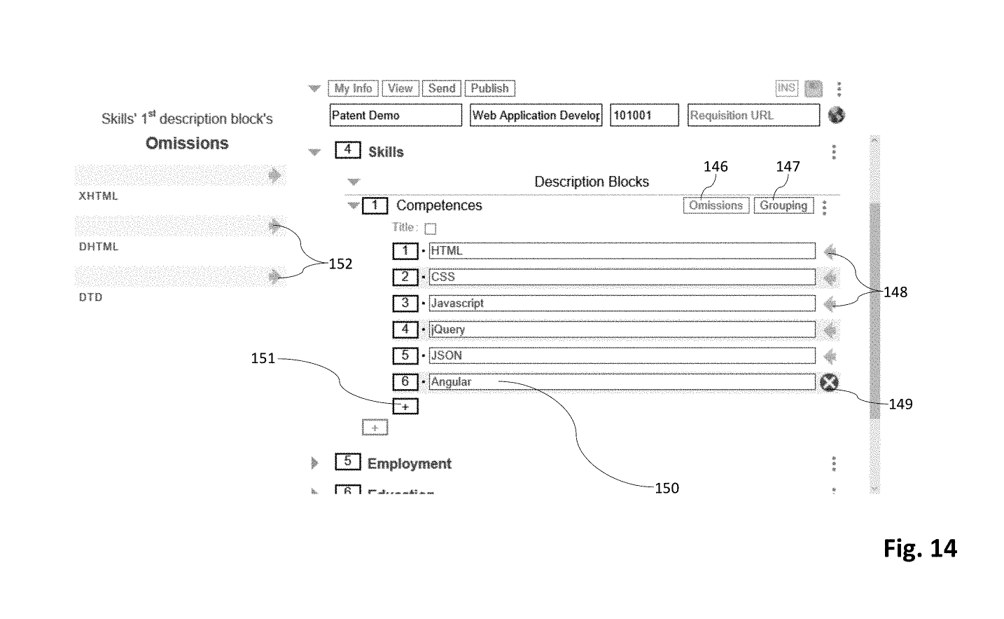

FIG. 14 shows controls a user can use to include previously-created items, remove irrelevant ones or, create new ones. Selecting one of buttons 152 can include an omitted item in the résumé by moving the item form the list of items omitted from the résumé to the list of included items. Selecting one of buttons 148 can remove an item from the résumé by moving the item from the list of included items to the list of items omitted from the résumé. A button 149 can delete an item from template and all résumés altogether. An add button 151 can be clicked to add a new control 150 into which a new item may be added. Also, a button 146, titled “Omissions”, when visible, indicates that items exist in the sidebar that are currently omitted but may be included and, clicking on button 146 will display the sidebar and a list of all of its grouping's omitted items. A button 147 titled “Groupings”, when applied, groups selected lists' items vertically, while displaying all lists in the grouping side-by-side horizontally. As indicated in FIG. 14, an item can include a competency, a skill, an item describing previous or past employments, current or past education or degrees and any other type of item that might appear in a résumé.

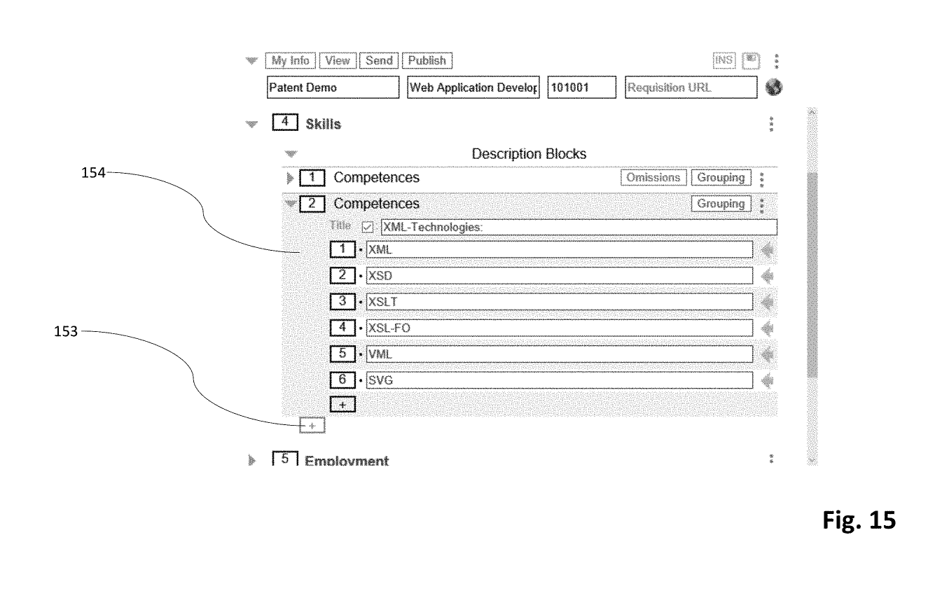

FIG. 15 shows how a user can add another group of items. A button 153, when clicked, adds a new list 154 whose items may be of another list type and, whose layout remains independent of other lists.

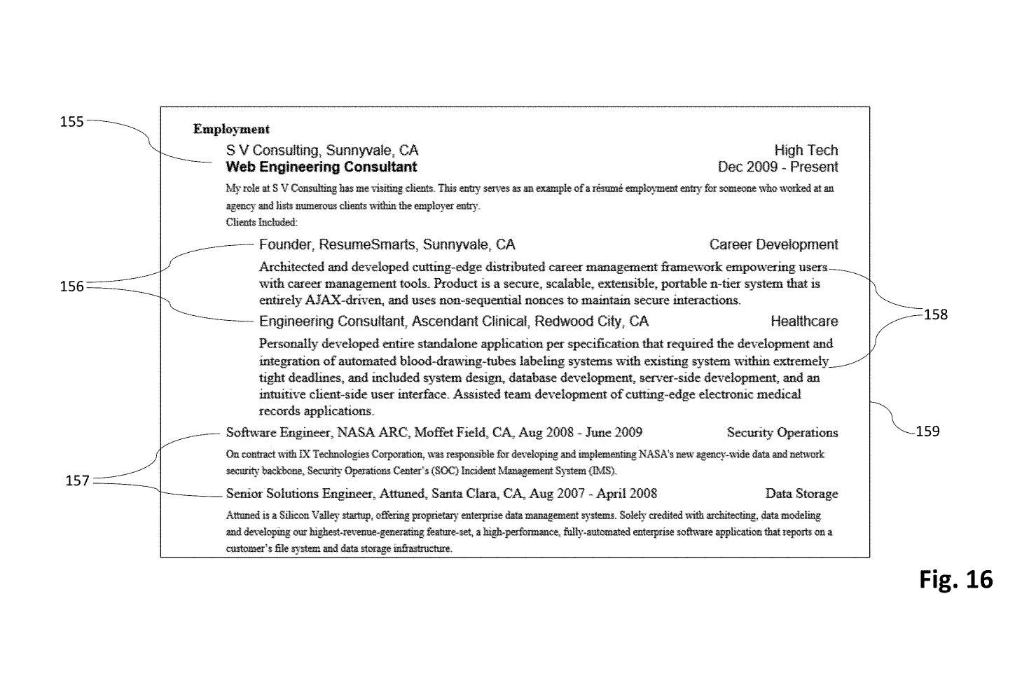

FIG. 16 demonstrates layout customization granularity, revealing how a position layout 155 may be modified so as not to conform to other position layouts 157 in its own grouping. Also illustrated is a layout 156 of client titles that, even when they appear to be formatted similarly to positions, they are easily discerned to be clients of their parent position due to their obvious visual indentation 158. An enclosure 159 indicates a viewport's boundaries in which résumé document is displayed, and vertically-scrolled when longer than viewport height.

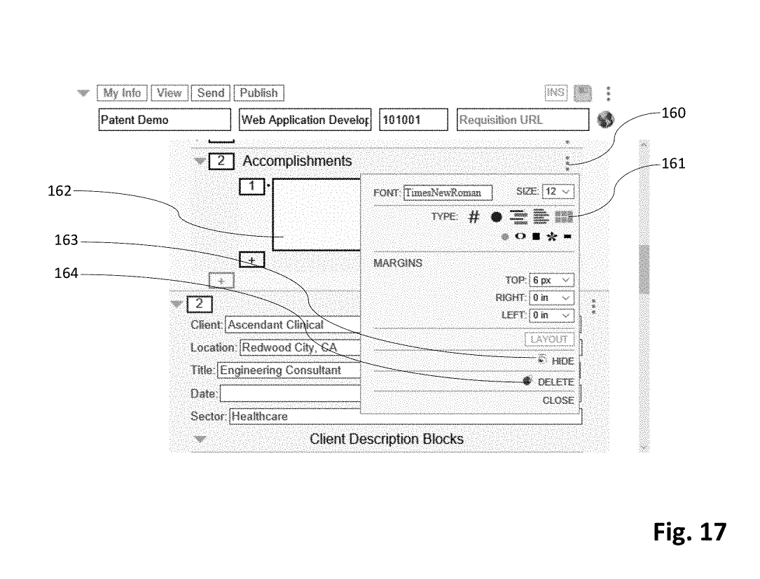

FIG. 17 primarily displays a menu that is accessed when changing a grouping's type to accomplishments. User 1003 clicks an image button 160 to access a menu button 161 that changes the item-type for selected grouping to accomplishments, as illustrated by a large control 162. Other menu options include a hide selection button 163 that hides entire grouping when its items are not relevant for targeted position and, a button 164 that deletes entire grouping of items from template and all résumés. A grouping of items can include, for example, a position and all items related to the position, a client and all items related to the client, an education program and all items related to the education program, an educational institution and all items related to the educational institution or any other grouping of individual items.

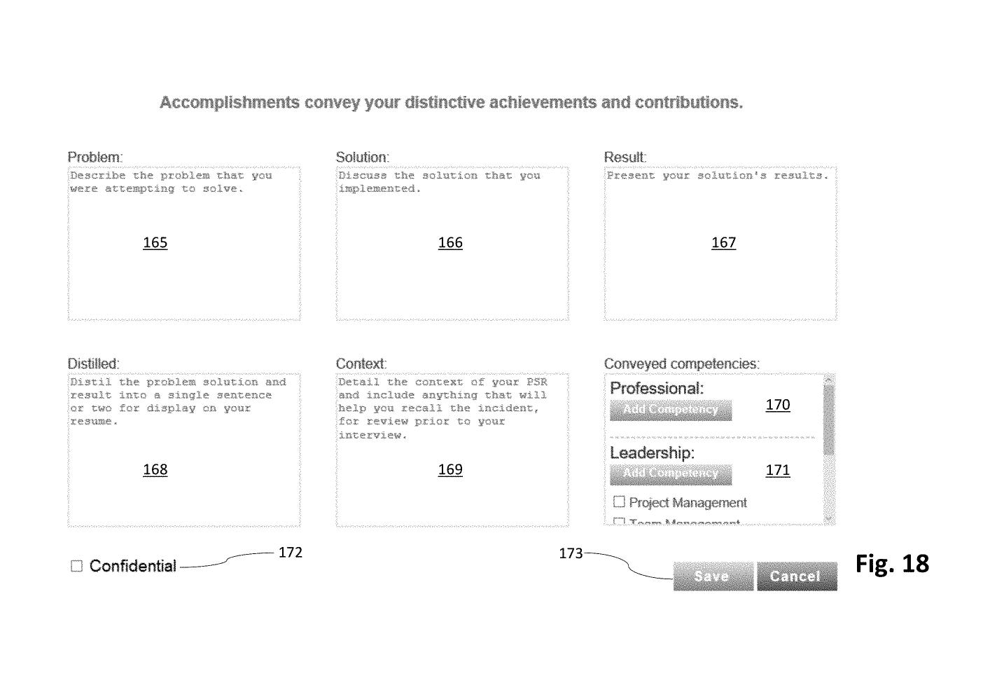

FIG. 18 displays an accomplishment-creation work-area, a tool that describes a problem that user 1003 solved for relevant employer or client or within an educational context, as described in FIG. 4. In a problem input area 165 is input a problem that user 1003 was assigned to resolve. In a solution input area 166 is input the solution that user 1003 devised and implemented. In a results input area 167 are summarized the results of the user's solution. In a distillation creation area 168, user 1003 distils information from problem input area 165, solution input area 166 and/or results input area 167 into the single sentence that will be displayed on the résumé. In a context input area 169, the user annotates the accomplishment to describe the event's context, and includes notations that help to clearly recall the incident prior to an interview and context input area 169 is later presented to user 1003 by in another internet application 1002 feature that assists with interview preparation. User 1003 labels accomplishments with relevant professional competencies that user 1003 has created within a grouping control 170, and also labels accomplishments with relevant leadership competencies that user has created within a grouping control 171. A checkbox 172 is checked by user 1003 to indicate that described accomplishment contains confidential information. A save button 173 can be clicked to save accomplishment.

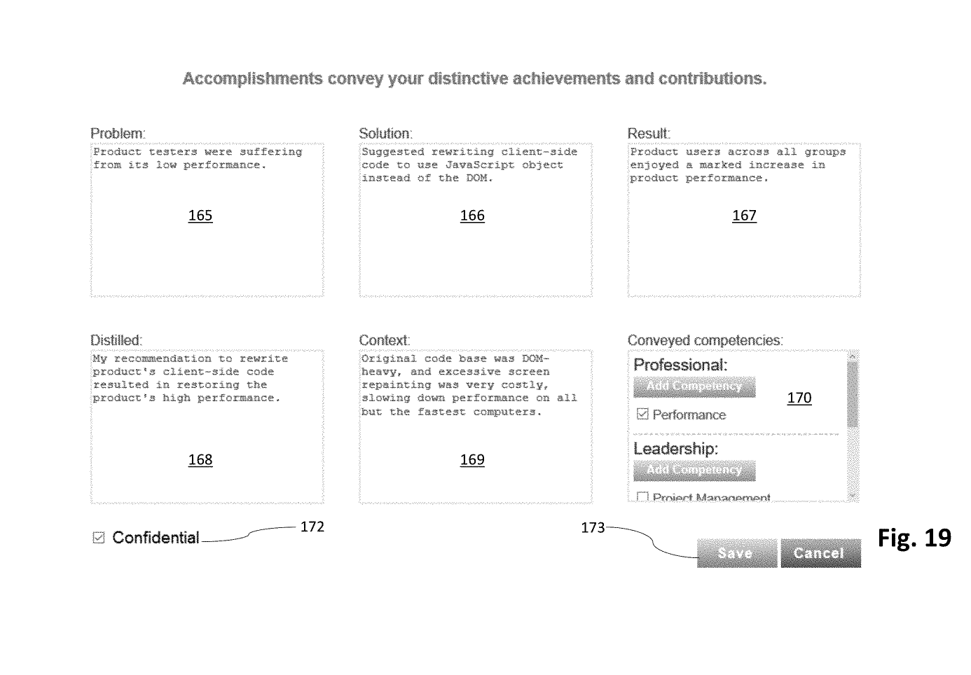

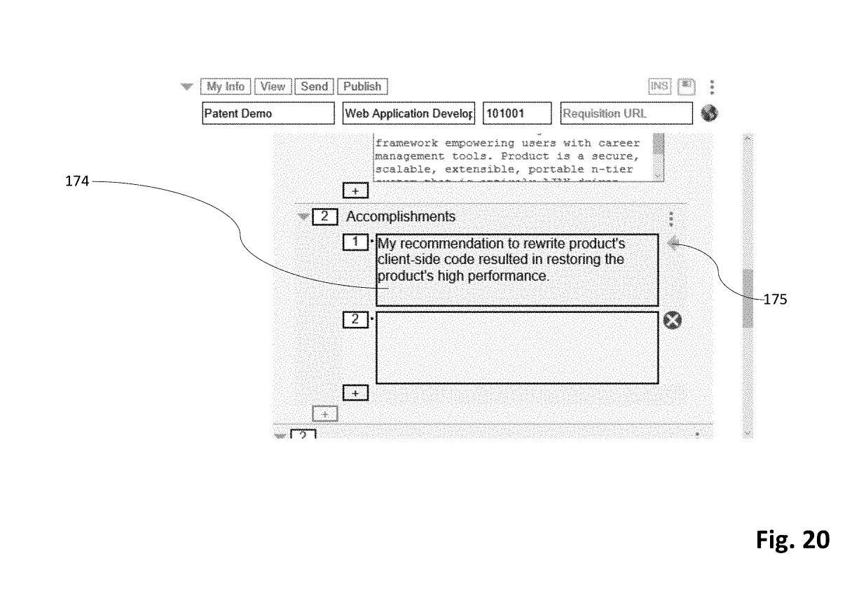

FIG. 19 displays an example of a completed accomplishment. In problem input textbox 165, user 1003 has described an assigned problem. In solution input textbox 166 is displayed a solution that user devised and implemented. In results input area 167, user 1003 summarized a solution's results. In distillation creation area 168, user 1003 distilled the problem, solution and/or result into a single sentence for display on the résumé. In context input area 169, user 1003 annotated the accomplishment and included notes to help recall the incident for review prior to an interview. User 1003 labeled accomplishment with a professional competency from grouping control 170 so that it is easier to find when seeking it for inclusion in a résumé's opening highlights. Confidential checkbox 172 was checked to indicate that accomplishment includes content of a secretive nature so that internet application 1002 will issue a warning when user attempts to publish it. Save button 155 was clicked to save the accomplishment, rendering accomplishment's distillation in résumé as depicted next in FIG. 20.

FIG. 20 reveals how a completed accomplishment is rendered in a template and résumé creation form, and displays accomplishment distillation in a box 174, and a button 175 that may be clicked to remove it from a résumé when it is not relevant to its targeted position requisition.

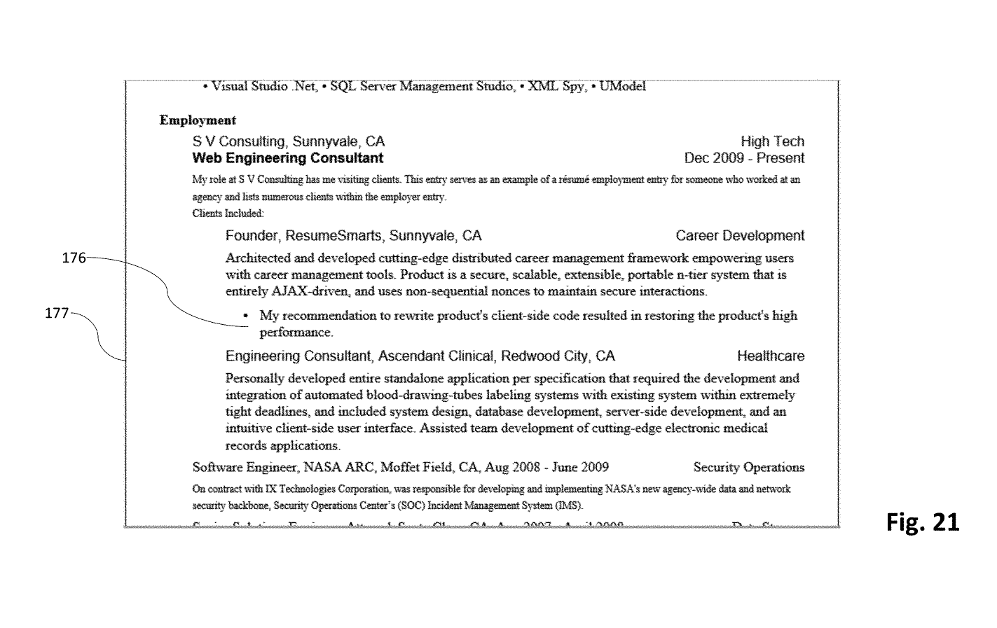

FIG. 21 illustrates the resulting résumé document and displays a selected rendering 176 for accomplishment within the context of its position's client as presented within a viewport 177.

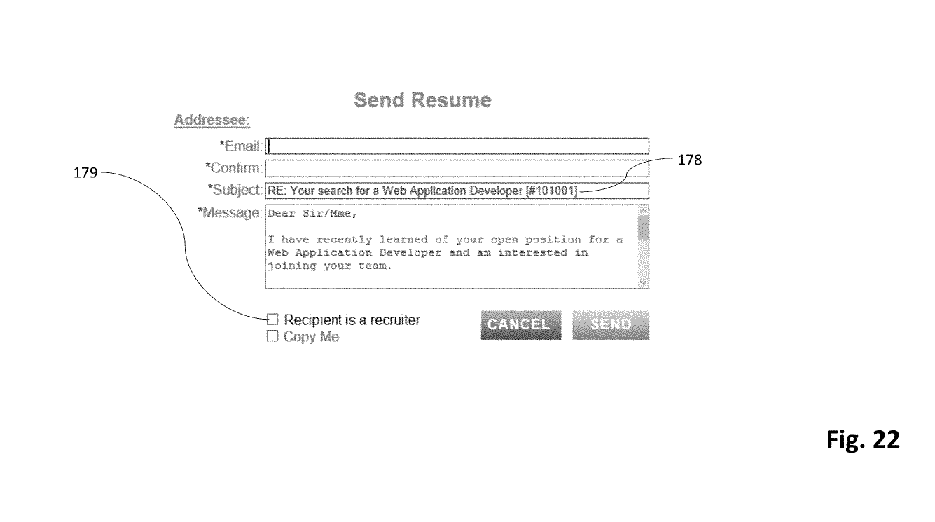

FIG. 22 exhibits an email form presented by internet application 1002 to user 1003 when sending a résumé to prospective employers or recruiters 1006. A subject textbox 178 is pre-filled by internet application 1002 with position name and requisition number as entered by employer in requisition, and as entered by user 1003 in FIG. 2's blocks 28 and 29, so that it has a better chance of passing through recipient server's 1005 spam filters and recipient's 1006 email-reader spam filters, and so that it attracts recipient's attention with an appealing subject. A checkbox 179 is checked by user 1003 to indicate that a recruiter is among recipients, so that internet application 1002 verifies whether a cross-agency conflict-of-interest may be present, as illustrated in FIG. 2, block 36.

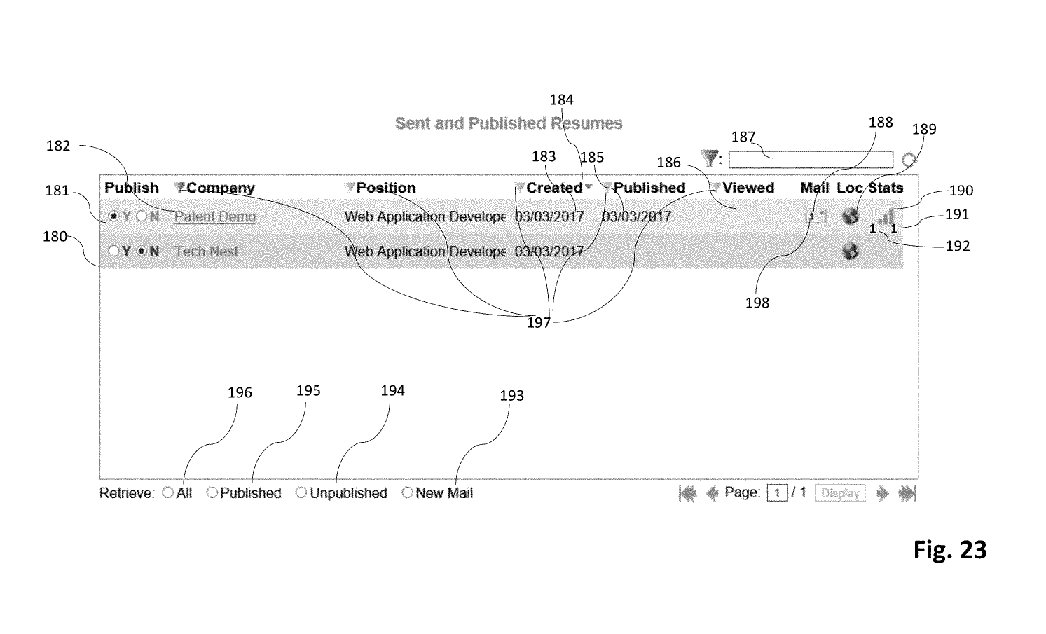

FIG. 23 displays a résumé publishing tool. The tool displays all résumés that user has either sent or published through internet application 1002 as illustrated in FIG. 2, blocks 39 and 44. The résumés are presented herein so that user 1003 may manage them and monitor their statistics, and to engage with employers and recruiters 1006 who contact user 1003 with inquiries of interest in filling their open positions. Published résumés omit their owners' names and contact information, are marked by internet application 1002 as available for presentation to public, and are indexed for search engine bots. User 1003 views published résumés within a viewport 180, and toggles a button 181 to either publish or rescind publication of its relevant résumé. User 1003 clicks on a résumé name 182 to view the same résumé as it is seen by public. User 1003 observes a creation date 183 when résumé was initially available for publication, and a triangle indicator 184 revealing that all listed résumés are sorted by that creation date, and its orientation pointing downward asserts that sort is in descending order. User 1003 observes résumés' publication dates in a column 185 and most recent viewed dates in a column 186. User filters résumés by typing into a textbox 187, which restricts listed résumés to those whose values match textbox 187's content in the current filtered column that is indicated by the emboldened member of a control set 197. User recognizes incoming mail from employers and recruiters 1006 by the presence of an image button 188, which also indicates in a control 198 the quantity of employers and recruiters 1006 whose active (unexpired) messages have not yet received a response. User clicks image button 188 to receive and to respond to incoming messages. User 1003 clicks an image button 189 to manage residential addresses. User observes an image button 190 that is present when published résumé has been viewed by employers and recruiters 1006, and notes an indicator 191 that reveals number of views that résumé has had since its birth date, and an indicator 192 that reveals number of messages that résumé has attracted since birth date 183. User clicks image button 190 to access detailed statistics on employers and recruiter who accessed the résumé in their search results and also detailed statistics on the search criteria and filters that employers and recruiters applied to their search when the relevant résumé was accessed. User 1003 clicks a radio button 193 to retrieve from internet application 1002 and list in viewport 180 only résumés that indicate that they have unanswered active messages from employers or recruiters 1006. User 1003 clicks a radio button 194 to retrieve from internet application 1002 and list in viewport 180 only those résumés that are unpublished. User clicks a radio button 195 to retrieve from internet application 1002 and list in viewport 180 only those résumés that are published. User 1003 clicks a radio button 196 to retrieve from internet application 1002 and list in viewport 180 all of user's résumés. Internet application 1002 provides employers and recruiters 1006 a search utility with which to search published résumés by résumé content, any of résumé owner's addresses, work permits per address and, other filtering criteria, and enables employers and recruiters 1006 to manage their searches per posted requisition, manage their interests in viewed résumés per requisition, contact candidates and other features.

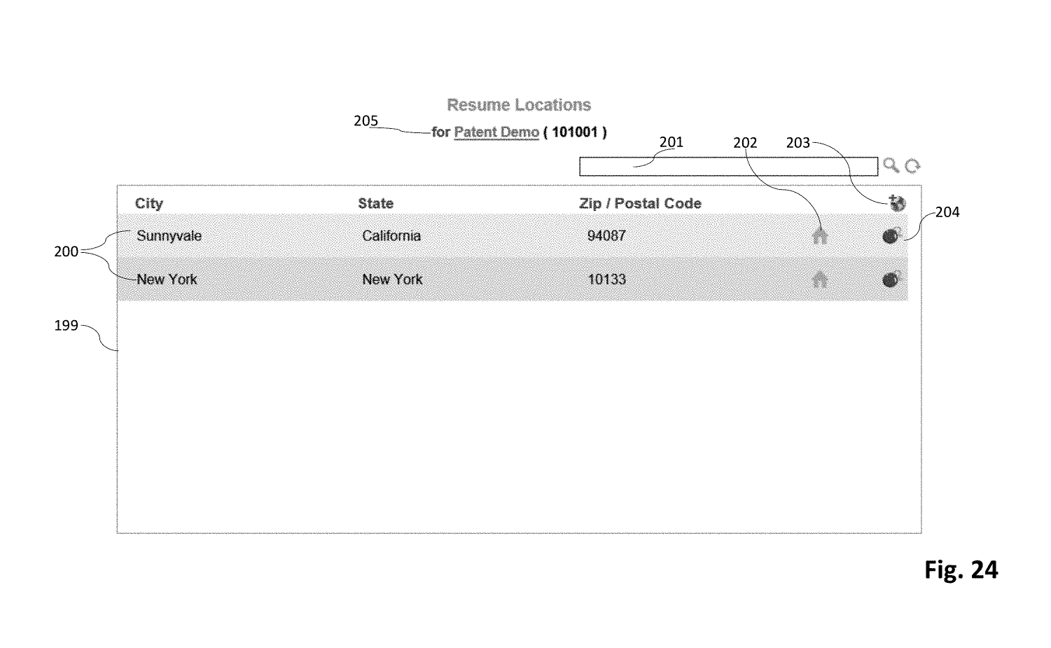

FIG. 24 presents user 1003 with a viewport 199 wherein residential addresses may be managed individually for a résumé 205. When user 1003 is passionately interested in working for a particular company, and has immediate access to an address that is relatively local to the location where the choice position is located, the addition of that address enables relevant employer or recruiter 1006 to access relevant résumé 205 while searching for local candidates, and assures employer 1006 that relocation expenditures will not be required for relevant candidate 1003. A viewport 199 contains the list of addresses and their management interface. Address rows 200 indicate active addresses and a textbox 201 filters the list of addresses listed in viewport 199 limiting them to those that contain a matching sequence of characters. An image button 202 indicates if user 1003 is legally permitted to work for employer at listed location or if otherwise a work permit may be required. An image button 203 adds a new location entry line below viewport 199's list and, an image button 204 is clicked to remove a location from the list.

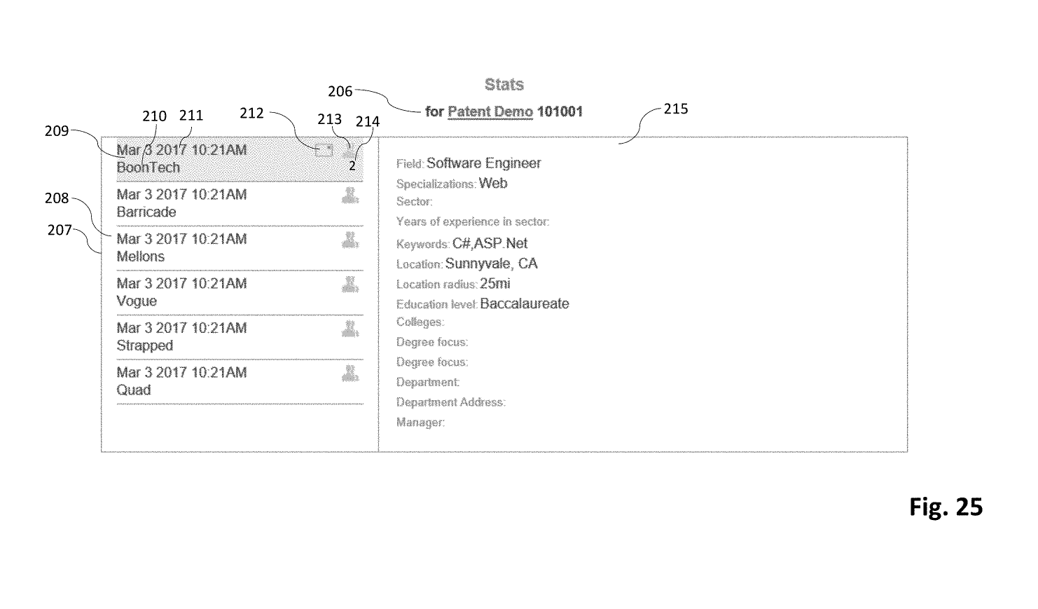

FIG. 25 represents a viewport 207 that reveals statistical data on employer and recruiter 1006 views that a relevant résumé 206 received. A list of employers and recruiters who retrieved the relevant résumé in a search 208 is displayed in the left section of viewport 207, where currently a single employer has been selected 209 as indicated by the visual cue. Selected employer 209 reveals an employer's company name 210, a date-stamp when résumé was initially viewed 211, an indication of received mail 212 and, an indication of other candidates whose résumés were of marked interest 213 and, an indication of the quantity of candidates who received mail while searching for candidates for relevant requisition 214. Viewport 207's right pane displays additional statistical data 215 about the searcher 1006 and about the search criteria and applied filters that caused résumé 206 to be present among search results. Statistical data 215 that are presented are uniquely different for each search, yet always include a link to relevant position requisition (not shown).

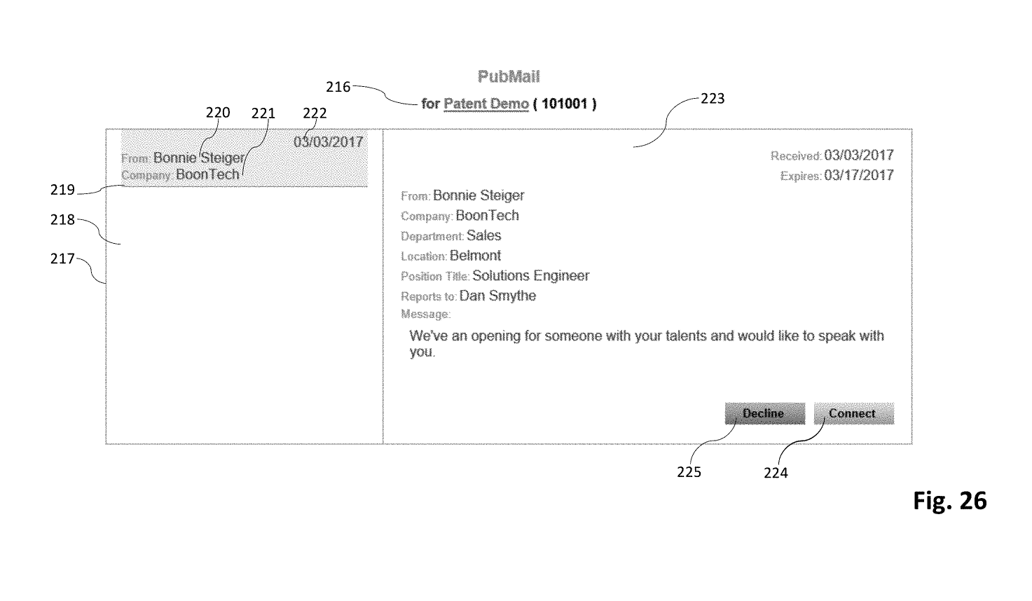

FIG. 26 represents a mail reader wherein user 1003 reads and optionally responds to messages of interest from employers and recruiters. A viewport 217 contains all communications, a left viewport pane 218 listing all relevant communications that were received when searcher viewed relevant résumé 216, and includes a timestamp 222 indicating the message date and time and, a searcher's login name 220 and a company name 221. A message in the viewport right pane 223 of viewport 217 indicates sender's message, date, expiration date and other statistical data about employer or recruiter and the position. A button 224 and a button 225 provide an interface where user 1003 may click button 224 to connect with message sender or otherwise click button 225 to decline the communication.

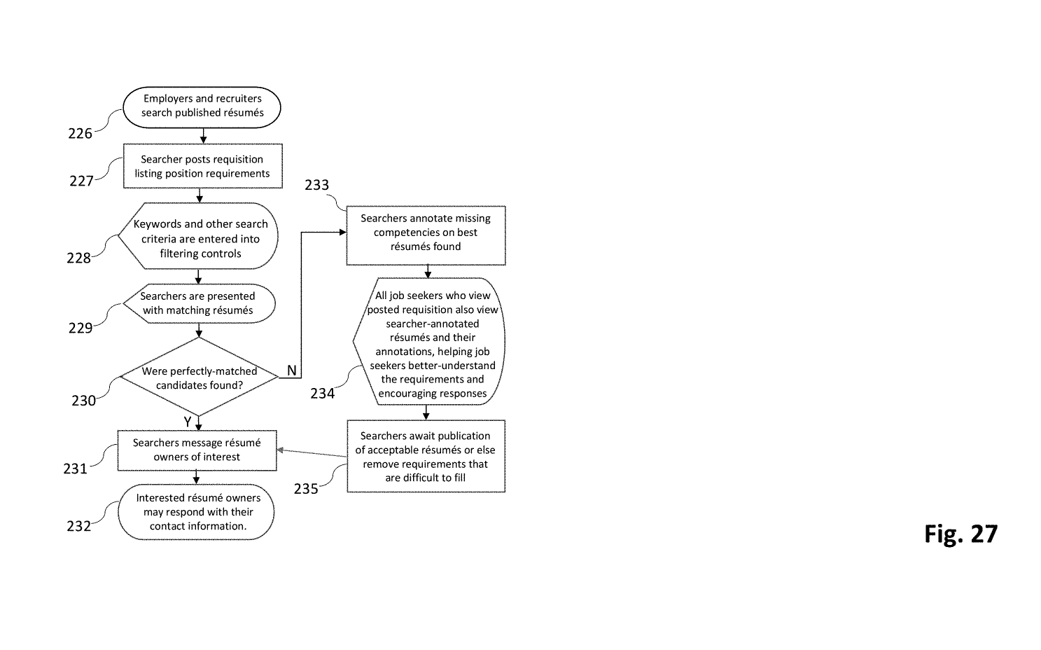

FIG. 27 represents a résumé search tool used by employers and recruiters 1006 who wish to search published résumés as indicated in a block 226. Initially employers and recruiters 1006 will post a requisition defining their requirements as indicated in a block 227. Internet application 1002 presents a form wherein searchers, i.e., employers and recruiters 1006, will input keywords and other search criteria into filtering controls as indicated in a block 228. Internet application 1002 presents employers and recruiters 1006 with résumés that best-match their search criteria as indicated in a block 229. If perfectly-matching résumés were found then searchers may message their owners with a request to discuss the opportunities as indicated in a block 231, and interested message recipients may request of internet application 1002 to connect them with the searchers by clicking button 224 in FIG. 26, and thus sharing their contact info with the searchers. However, if perfectly-matching résumés are not found then employers and recruiters 1006 may annotate the best résumés that were found and indicate in each one where it falls short of perfection, as indicated in a block 233. Internet application 1002 displays annotated résumés along with searcher annotations to all job seekers who view their associated posted requisitions, offering insights to job seekers on their positions' requirements and inspiring qualified job seekers to respond by publishing better-matching résumés, as indicated in a block 234. Employers and recruiters 1006 await publication of better-matching résumés, and optionally reduce the requirements to attract more qualified personnel, as indicated in a block 235. Once connections are made the conversations between searcher and candidate remain independent of internet application 1002.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A résumé tool used to build a résumé, comprising:
a résumé customization tool that adds and removes items to a selected résumé, the résumé customization tool including for each résumé:
a list of included items,
a list of items omitted from the résumé,
a hide selection that moves an item or a grouping of items from the list of included items to the list of items omitted from the résumé, and
a selection that moves an item or grouping of items from the list of items omitted from the résumé to the list of included items.

2. A résumé tool as in claim 1 additionally comprising:
an accomplishment-creation tool that allows accomplishments to be linked to competencies, the accomplishment-creation tool including:
a problem input area where a user can describe a problem that was solved,
a solution input area where the user describes a solution that was implemented,
a results input area where the user describes the solution results, and
a distillation creation area where the user inputs the problem solution and result into a single sentence or two for display on the résumé.

3. A résumé tool as in claim 2, wherein the accomplishment-creation tool additionally includes:
a context input area where the user can annotate a context of the problem, the solution and the result.

4. A résumé tool as in claim 2 wherein the accomplishment-creation tool additionally includes:
a confidential check box the can be selected to indicate that an accomplishment is to be kept confidential.

5. A résumé tool as in claim 2 wherein the accomplishment-creation tool additionally includes:
a grouping control that labels accomplishments with relevant professional competencies that the user has created.

6. A résumé tool as in claim 2 wherein the résumé customization tool additionally includes:
a grouping control that labels accomplishments with relevant leadership competencies that the user has created.

7. A résumé tool as in claim 1, additionally comprising:
layout customization so clients serviced by a user when the user worked for the employer are indented in a position layout for the employer.

8. A résumé tool as in claim 1, additionally comprising:
a publisher tool that publishes a plurality of résumés for a user, the publisher tool removing name and contact information of the user before publishing each résumé for the user

9. A résumé tool as in claim 8, wherein the publisher tool tracks for each résumé, each searcher who viewed the résumé.

10. A résumé tool as in claim 8, wherein the publisher tool includes a search feature by which prospective employers and recruiters can search the published résumés for résumés that match requirements for a prospective job.

11. A résumé tool as in claim 10 wherein the publisher tool includes a feature by which prospective employers and recruiters can request from users, additional information about items not listed on a résumé, wherein requests for additional information from one user is published and available to all users of the résumé tool.

12. A résumé tool as in claim 10 wherein the publisher tool includes a communication feature by which prospective employers and recruiters can send to users, communication pertaining to résumés and potential jobs.

13. A résumé tool as in claim 1 wherein the résumé tool allows multiple residence locations to be added to a single résumé, the multiple residence locations indicating locations the user can work without requiring moving or relocation expense reimbursement.

14. A résumé tool as in claim 13 wherein the résumé tool allows the user to indicate where working at a location near a particular residence will require the user to acquire a work permit.

15. A résumé tool used to build a résumé, comprising:
an accomplishment-creation tool that allows accomplishments to be linked to competencies, the accomplishment-creation tool including:
a problem input area where a user can describe a problem that was solved,
a solution input area where the user describes a solution that was implemented,
a results input area where the user describes the solution results, and
a distillation creation area where the user inputs the problem solution and result into a single sentence or two for display on the résumé.

16. A résumé tool as in claim 15 wherein the accomplishment-creation tool additionally includes:
a context input area where the user can annotate a context of the problem, the solution and/or the result.

17. A résumé tool as in claim 15 wherein the accomplishment-creation tool additionally includes:
a confidential check box the can be selected to indicate that an accomplishment is to be kept confidential.

18. A résumé tool as in claim 15 wherein the accomplishment-creation tool additionally includes:
a first grouping control that labels accomplishments with relevant professional competencies that the user has created; and,
a second grouping control that labels accomplishments with relevant leadership competencies that the user has created.

19. A résumé tool used to build a résumé, comprising:
a publisher tool that publishes a plurality of résumés for a user, the publisher tool removing name and contact information of the user before publishing each résumé for the user, wherein the publisher tool tracks for each résumé, each searcher who viewed the résumé, the plurality of résumés being available for search by prospective employers and recruiters searching for résumés that match requirements for a prospective job; and,
a communication feature by which users receive from prospective employers and recruiters, communications pertaining to résumés and potential jobs, the communication feature including an interface that allows a user to respond to a communication by connecting with the sender of the communication or declining to communicate.

20. A résumé tool as in claim 19 wherein the publisher tool includes a feature by which prospective employers and recruiters can request from users, additional information about items not listed on a résumé, wherein requests for additional information from one user is published and available to all users of the résumé tool.
